(19) United States
(12) Patent Application Publication
(10) Pub. No.: US 2025/0180828 A1
(43) Pub. Date: Jun. 5, 2025

(54) EXPANDED BEAM CONNECTORS AND ASSOCIATED SYSTEMS AND METHODS

(71) Applicant: CORNING RESEARCH & DEVELOPMENT CORPORATION, CORNING, NY (US)

(72) Inventor: Scott Robertson Bickham, Corning, NY (US)

(21) Appl. No.: 19/045,851

(22) Filed: Feb. 5, 2025

Related U.S. Application Data
(63) Continuation of application No. PCT/US2023/029274, filed on Aug. 2, 2023.
(60) Provisional application No. 63/396,479, filed on Aug. 9, 2022.

(51) Int. Cl. G02B 6/38; G02B 6/255; G02B 6/26

(52) U.S. Cl. CPC G02B 6/3885; G02B 6/2551; G02B 6/3846; G02B 6/262

(57) ABSTRACT

An expanded beam connector and method of making the same is provided herein. The expanded beam connector includes an array of spliced optical fibers, each spliced optical fiber including a first optical fiber and a second optical fiber spliced to the first optical fiber at a splice position. The second optical fiber defines a fiber length extending between the splice position and the cut position configured as a quarter-pitch length. At the quarter-pitch length, a wave transmission through the second optical fiber causes the wave to collimate at the cut position. The expanded beam connector further includes a connector surrounding at least the splice position of each spliced optical fiber within the array of spliced optical fibers.

### RELATED APPLICATIONS

This application is a continuation of International Patent Application No. PCT/US2023/029274 filed on Aug. 2, 2023, which claims the benefit of priority to U.S. Provisional Application Ser. No. 63/396,479, filed Aug. 9, 2022, the content of which is relied upon and incorporated herein by reference in its entirety.

### FIELD

Embodiments of the present invention relate generally to forming optical connectors, and more particularly to accurately calculating quarter-pitch lengths for optical fibers used in forming a fiber array for use in expanded beam connectors.

### BACKGROUND

Benefits of optical communication include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and inter-rack connections. Accordingly, optical connectors are employed in both optical cable assemblies and electronic devices to provide an optical-to-optical connection where optical signals are passed between an optical cable assembly and an electronic device.

Optical devices, such as optical connectors, may include optical elements secured, for example, to v-grooves of a substrate or secured into the micro-holes of a ferrule. The optical connectors may then be connected to another optical device to provide optical communication between optical devices. For optimal data communication between optical connectors, optical fiber connectors need to be aligned to accurately and efficiently transmit data between the optical fibers of the connectors. Coupling losses between two optical connectors may occur due to lateral or angular misalignments of the optical fibers relative to the center of the v-grooves or micro-holes and/or variations in the pitch of the optical fibers. In addition, the optical fibers need to be in physical contact with the optical element to which it is coupled to ensure that there is minimal degradation of insertion loss and return loss performance.

### SUMMARY

Embodiments of the present disclosure are directed towards expanded beam connectors, comprised of an array of precision-length multimode fiber (MMF) gradient-index (GRIN) lenses. The expanded-beam connector may comprise an array of single-mode optical fibers spliced to an array of precision-length MMF GRIN lenses, wherein the length of the MMF determines the output characteristics of the expanded beam. In order to provide a consistent output characteristic for all of the optical fibers within the expanded-beam connector, the MMF GRIN lens needs to be trimmed to an accurate fiber length. The MMF length may be a multiple of a quarter-pitch length. A quarter-pitch length is defined by the actions of the light propagating within the MMF GRIN lens. Notably, at a quarter-pitch length, the signal exits the optical fiber in a configuration different than the signal entered the optical fiber (e.g., enters collimated exits focused; enters focused exits collimated and expanded).

The quarter-pitch length accounts for a maximum relative refractive index, the core radius, and the core curvature. Using these factors the quarter-pitch length may define a tolerance of ±5 microns. The small variation allows similar MMFs to be used to create a precision-length GRIN lens array (particularly at scale), where the signal exiting from the MMF GRIN lens is a collimated expanded beam, for each element of the expanded-beam connector. In this regard, providing for small variation allows for a single cut for all fibers to occur (e.g., at a multiple of the quarter-pitch length) that still results in desired performance by all of the fibers in an expanded-beam connector—thereby allowing for scalability of production while ensuring common signal characteristics at the cut position.

In an example embodiment, an expanded beam connector is provided. The expanded beam connector comprises an array of spliced optical fibers. Each of the spliced optical fibers within the array of optical fibers comprises a first optical fiber and a second optical fiber spliced with the first optical fiber at a splice position. The first optical fiber is a single-mode fiber, and the second optical fiber is a gradient-index multimode fiber. The second optical fiber defines a fiber length extending between the splice position and a cut position. The cut position is the same for each of the second optical fibers of the array of spliced optical fibers. The fiber length is configured as a multiple of a quarter-pitch length. At the quarter-pitch length a wave transmission through the second optical fiber between the splice position and the cut position causes the wave to collimate at the cut position. The expanded beam connector further comprises a connector surrounding at least the splice position of each spliced optical fiber within the array of spliced optical fibers.

In some embodiments, the quarter-pitch length may be based on a core radius of the second optical fiber, a maximum relative refractive index of the second optical fiber, and a core alpha value of the second optical fiber.

In some embodiments, the quarter-pitch length may be provided by the following equation:

$${L}_{\frac{1}{4}} = \frac{π a}{2} \sqrt{\frac{1 - 2 {Δ}_{0}}{2 {C}_{α} {Δ}_{0}}} ,$$

wherein L_{1/4}, is the quarter pitch length, a is the core radius of the second optical fiber Δ₀ is the maximum relative refractive index of the second optical fiber, α is the core alpha of the second optical fiber, and

$${C}_{α} = 1 + \frac{1}{a} {\int }_{0}^{a} ( 2 - α ) {( \frac{r}{a} )}^{( 2 - α )} ln ( \frac{r}{a} ) .$$

In some embodiments, the second optical fiber may comprise a core radius between 24-26 microns. In some embodiments, the second optical fiber comprises a maximum relative refractive index between 0.95%-1.05%. In some embodiments, the quarter-pitch length may be between 268-299 microns. In some embodiments, the quarter-pitch length of each of the second optical fibers may be within a threshold error length that is less than ±20 microns. In some embodiments, the threshold error length may be less than ±10 microns.

In some embodiments, the wave transmission may be a light with a wavelength between 1520 nm and 1620 nm. In some embodiments, the second optical fiber may comprise a minimum effective modal bandwidth value at 850 nm of greater than 4700 MHz-km.

In some embodiments, the wave transmission may be a light with a wavelength between 1260 nm and 1360 nm. In some embodiments, the second optical fiber may comprise a minimum effective modal bandwidth value at 1310 nm of greater than 4000 MHz-km.

In some embodiments, the expanded beam connector may be contactless. In some embodiments, the expanded beam connector may further comprise an anti-reflection coating disposed on the cut end of the second optical fiber. In some embodiments, the expanded beam connector may further comprise a ferrule enclosed within the connector, and the second optical fiber may be positioned within the ferrule. In some embodiments, the plurality of second optical fibers may be recessed within the ferrule. In some embodiments, the fiber length may be between 100-5000 microns.

In another example embodiment, a method of making an expanded beam connector is provided. The method comprises forming a plurality of spliced optical fibers by splicing a plurality of first optical fibers to a plurality of second optical fibers at a splice position. The plurality of first optical fibers are single-mode fibers, and the plurality of second optical fibers are gradient-index multimode fibers. The method further comprises forming an array of spliced optical fibers. The splice positions of each of the plurality of spliced optical fibers are aligned. The method further comprises by determining a quarter-pitch length of the plurality of second optical fibers within the plurality of spliced optical fibers. The quarter-pitch length is configured such that a wave transmission traveling through the plurality of second optical fibers collimates at a cut position, wherein the cut position is opposite the splice position. The method further comprises trimming the plurality of second optical fibers to a fiber length. The fiber length being a multiple of the quarter-pitch length. The method further comprises positioning the array of spliced optical fibers in a connector. At least a portion of the plurality of first optical fibers, the splice position, and the plurality of second optical fibers are within the connector housing.

In some embodiments, the quarter pitch length may be may be provided by the following equation:

$${L}_{\frac{1}{4}} = \frac{π a}{2} \sqrt{\frac{1 - 2 {Δ}_{0}}{2 {C}_{α} {Δ}_{0}}} ,$$

wherein L_{1/4}, is the quarter pitch length, a is the core radius of the second optical fiber Δ₀ is the maximum relative refractive index of the second optical fiber, α is the core alpha of the second optical fiber, and

$${C}_{α} = 1 + \frac{1}{a} {\int }_{0}^{a} ( 2 - α ) {( \frac{r}{a} )}^{( 2 - α )} ln ( \frac{r}{a} ) .$$

In some embodiments, the method may further comprise positioning a cut end of the plurality of second optical fibers into a ferrule. The cut end of the plurality of second optical fibers may be recessed in the ferrule.

In yet another example embodiment, an optical data transmission system is provided. The optical data transmission system comprising an expanded beam connector, a connector, and a light source. The expanded beam connector comprises an array of spliced optical fibers. Each of the spliced optical fibers within the array of optical fibers comprises a first optical fiber and a second optical fiber spliced with the first optical fiber at a splice position. The first optical fiber is a single-mode fiber, and the second optical fiber is a gradient-index multimode fiber. The second optical fiber defines a fiber length extending between the splice position and a cut position. The cut position being the same for each of the second optical fibers of the array of spliced optical fibers. The fiber length is configured as a multiple of a quarter-pitch length. At the quarter-pitch length a wave transmission through the second optical fiber between the splice position and the cut position causes the wave to collimate at the cut position. The connector of the optical data transmission system surrounds at least the splice position of each spliced optical fiber within the array of spliced optical fibers. The at least one light source of the optical data transmission system is configured to transmit the wave through the array of spliced optical fibers at a bit rate of at least 25 Gb/s.

In some embodiments, the quarter pitch length may be may be provided by the following equation:

$${L}_{\frac{1}{4}} = \frac{π a}{2} \sqrt{\frac{1 - 2 {Δ}_{0}}{2 {C}_{α} {Δ}_{0}}} ,$$

wherein L_{1/4}, is the quarter pitch length, a is the core radius of the second optical fiber Δ₀ is the maximum relative refractive index of the second optical fiber, α is the core alpha of the second optical fiber, and

$${C}_{α} = 1 + \frac{1}{a} {\int }_{0}^{a} ( 2 - α ) {( \frac{r}{a} )}^{( 2 - α )} ln ( \frac{r}{a} ) .$$

In some embodiments, the optical data transmission system may further comprise an anti-reflection coating disposed on a cut end of the second optical fiber.

In yet another example embodiment, a contactless optical fiber connector is provided. The contactless optical fiber connector comprises an array of spliced optical fibers. Each spliced optical fiber within the array of spliced optical fiber comprises a first optical fiber and a second optical fiber spliced with the first optical fiber at a splice position. The first optical fiber is a single-mode fiber comprising a 15 mm diameter bend loss that is less than 1 dB/turn. The second optical fiber is a gradient-index multimode fiber. The second optical fiber defines a fiber length extending between the splice position and a cut position. The cut position is the same for each of the second optical fibers of the array of spliced optical fibers. The fiber length is configured as a multiple of a quarter-pitch length. At the quarter-pitch length a wave transmission through the second optical fiber between the splice position and the cut position causes the wave to collimate at the cut position. The cut position of each of the second optical fiber within the array of spliced optical fibers is positioned within a ferrule. The contactless optical fiber connector further comprises a connector surrounding at least a portion of the first optical fibers within the array of spliced optical fibers and the ferrule. The connector is configured to be connected to a second connector.

### BRIEF DESCRIPTION OF THE DRAWINGS

Reference will now be made to the accompanying drawings, which are not drawn to scale, and wherein:

FIG. 1 illustrates an isometric view of an example fiber array unit, in accordance with some embodiments discussed herein;

FIGS. 2A-E illustrate isometric views illustrating forming an example fiber array, in accordance with some embodiments discussed herein;

FIG. 3A illustrates an example cable assembly with a multi-fiber push-on (MPO) connector, in accordance with some embodiments discussed herein;

FIG. 3B illustrates an example connector of the example cable assembly illustrated in FIG. 3A, in accordance with some embodiments discussed herein;

FIGS. 4A-F illustrate cross-sectional views of gradient-index lens, with varying input and output characteristics, in accordance with some embodiments discussed herein;

FIG. 5 illustrates a cross-sectional view of propagation of a Gaussian beam across a connection interface between optical fibers, in accordance with some embodiments discussed herein;

FIG. 6A illustrates imaginary components of q2 for a MMF GRIN lens for one full pitch, in accordance with some embodiments discussed herein;

FIG. 6B illustrates real components of q2 for a MMF GRIN lens for one full pitch, in accordance with some embodiments discussed herein;

FIG. 7A illustrates a graph illustrating the half-width of a beam transmitted through a GRIN-MMF lens for a full pitch, in accordance with some embodiments discussed herein;

FIG. 7B illustrates a graph illustrating the half-width of a beam transmitted through a GRIN-MMF lens for a quarter pitch, in accordance with some embodiments discussed herein;

FIG. 8A illustrates a graph illustrating a half-width of a beam transmitted through a GRIN-MMF lens for one full pitch, with a core diameter of 100 microns, in accordance with some embodiments discussed herein;

FIG. 8B illustrates a graph illustrating a half-width of a beam transmitted through a GRIN-MMF lens for a quarter pitch, with a core diameter of 100 microns, in accordance with some embodiments discussed herein;

FIG. 9 illustrates a graph depicting the quarter-pitch length verses alpha form different values of the maximum relative refractive index, and a core radium of 25 microns, in accordance with some embodiments discussed herein;

FIG. 10 illustrates a graph depicting the dependence of the quarter pitch length versus alpha for varying core radii and a maximum reflective refractive index of 1.0%, in accordance with some embodiments discussed herein; and

FIG. 11 illustrates a flow chart of an example method for forming a connector, in accordance with some embodiments discussed herein.

### DETAILED DESCRIPTION

Some example embodiments will not be described more fully herein with reference to the accompanying drawings, in which some, but not all example embodiments are shown. Indeed, the examples described and pictured herein should not be construed as being limiting to the scope, applicability or configuration of the present disclosure. Rather, these example embodiments are provided so that this disclosure will satisfy applicable legal requirements. Like reference numerals refer to like elements throughout.

Embodiments of the present invention provide for expanded beam connectors utilizing precision-length MMF GRIN lenses, multiple-fiber connectors comprising precision-length MMF GRIN lenses and methods of making precision-length MMF GRIN lenses and expanded beam connectors.

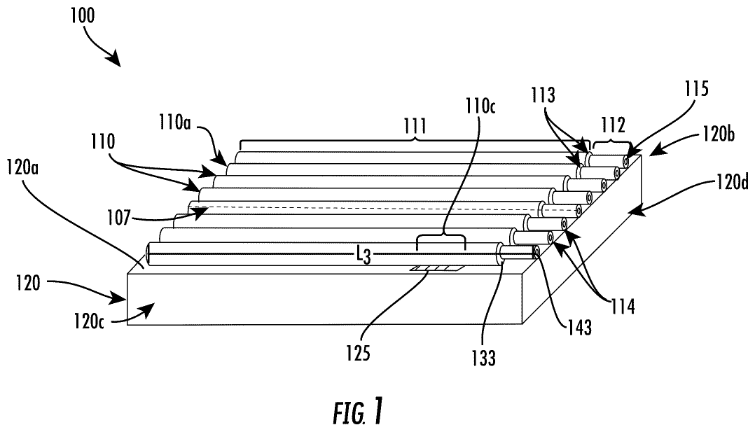

As discussed above, optical fibers may be manipulated to collect, guide or transmit propagating photonic information in communication devices. FIG. 1 illustrates an example fiber array unit (FAU) 100, having an optical fiber 110 disposed on a film 125 positioned on a surface 120a of a substrate 120. The optical fiber 110 may be laser welded to the surface 120a of the substrate 120 by directing heat towards the film 125. In some embodiments, other bonding methods may be used to weld the optical fiber 110 on to the surface 120a of the substrate 120. Notably, the optical fiber 110 may be laser welded to the substrate with methods as disclosed within U.S. Pat. No. 10,345,533, entitled “Assemblies, Optical Connectors and Methods of Bonding Optical Fibers to Substrates”, filed Feb. 15, 2018; U.S. Pat. No. 10,422,961, entitled “Fiber Array Formed Using Laser Bonded Optical Fibers”, filed February Oct. 11, 2018; U.S. Pat. No. 10,545,293, entitled “Assemblies, Optical Connectors and Methods of Bonding Optical Fibers to Substrates”, filed May 13, 2019; and U.S. Pat. No. 10,746,937, entitled “Assemblies, Optical Connectors and Methods of Bonding Optical Elements to Substrates”, filed Oct. 25, 2019, which are assigned to the Assignee and Applicant of this application, and which are each incorporated by reference herein in their entireties.

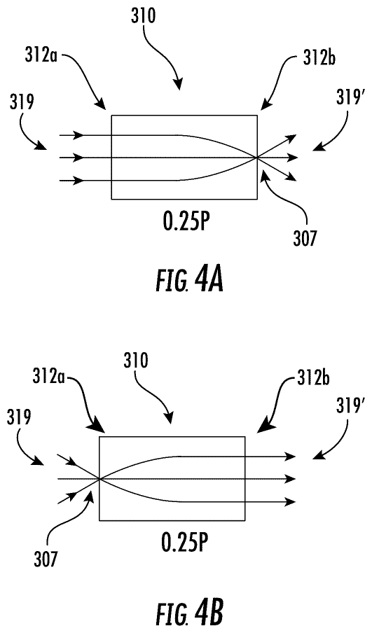

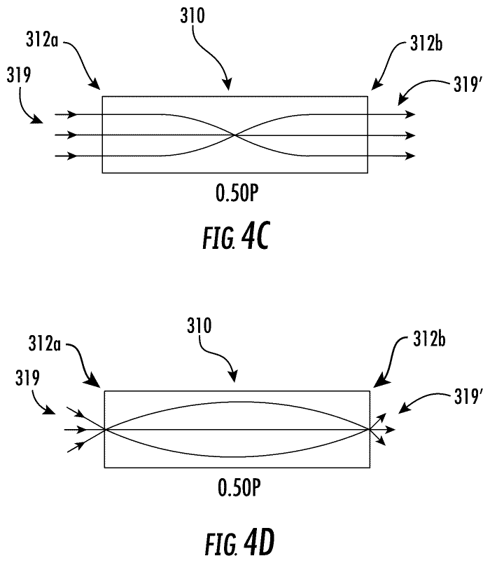

In some embodiments, the optical fiber 110, may define a length L3 extending between a first end 110a and a cut end 115. An optical pathway 107 may extend along the length L3 of the optical fiber 110. In some embodiments, the optical pathway 107 is configured such that the length L3 of the optical fiber 110 defines an output characteristic of optical signals extending from the cut end 115 of the optical fiber 110, and thereby the optical pathway 107. In some embodiments, the optical pathway 107 may extend through a core 114 of the optical fiber 110. The core 114 may be surrounded by cladding 133 which may contribute to the refractive characteristics of the optical fiber 110. In some embodiments, the length L3 of the at least one optical fiber 110 may determine output characteristics of the optical fiber 110. In this regard, a portion of the optical fiber 110 may define an optical variation portion where the output characteristics of output signals vary depending on the position along the optical variation portion. By positioning the cut end 115 at different positions along the optical variation portion, different output characteristics may be obtained (e.g., choosing where to position the cut end 115 allows for customized output characteristics). The output characteristics may be, for example, focusing, collimating, and/or diverging characteristics of a ray and/or beam (see e.g., FIGS. 4A-F) propagating within the optical fiber 110.

In some embodiments, the cut end 115 of the optical fiber 110 may be aligned with an end face 120d of the substrate 120. In some embodiments, the cut end 115 of the optical fiber 110 may be recessed from an end face 120d of the substrate 120.

The cut end 115 may be inserted into a ferrule, a v-groove or other optical coupling device to transfer and transmit data and optical information between the optical fiber 110 and another device. In some embodiments, the cut end 115 of the optical fiber 110 may be recessed from the end face of a ferrule, a v-groove or other optical coupling device to transfer and transmit data and optical information between the optical fiber 110 and another device.

In some embodiments, as illustrated in FIG. 1, the optical fiber 110 may be formed from a first optical fiber 111 and a second optical fiber 112 spliced together at a splice position 113. In some embodiments, the film 125 is disposed under a portion 110c of the first optical fiber 111, and the cut end 115 is on the second optical fiber 112. In some embodiments, the portion 110c of the optical fiber may extend across the surface 120a of the substrate 120, while in other embodiments, the portion 110c may extend partially across the surface 120a of the substrate 120.

In some embodiments, the optical fiber 110 is an 8 optical fiber ribbon positioned on the surface 120a of the substrate 120, wherein the optical fibers 110 extend from a first side 120c of the substrate 120 to a second side 120b of the substrate 120. In some embodiments, optical fibers 110 in the fiber ribbon may extend between the first side 120c to the second side 120b of the substrate 120, while in other embodiments, the optical fibers 110 within the fiber ribbon may extend partially between the first side 120c and the second side 120b.

In some embodiments, the optical fibers 110 may be ribbonized (e.g., adhered to one another), either in a flat configuration or in a rollable configuration wherein the optical fibers 110 are intermittently bonded.

In some embodiments, the first optical fiber 110 may be a single mode fiber. The single mode fiber supports only one linearly-polarized (LP₀₁) mode per polarization direction at the system wavelength. In some embodiments, the first optical fiber 110 may have a low bend-loss, for example less than 1 dB when wrapped around a 25 mm diameter mandrel, less than 1 dB when wrapped around a 20 mm diameter mandrel and, more preferably, less than 1 dB when wrapped around a 15 mm diameter mandrel. In some embodiments, the first optical fiber 110 may comprise a step-index core. In some embodiments, the first optical fiber 110 may comprise a rounded-step index core. In some embodiments, the first optical fiber 110 may comprise a core having an alpha value greater than 10. In some embodiments, the first optical fiber 110 may comprise a gradient-index core. In some embodiments, the first optical fiber 110 may comprise a core having an alpha value less than 10. In some embodiments, the first optical fiber 110 may comprise a 22 m cutoff wavelength of less than 1260 nm, less than 1230 nm or more preferably less than 1200 nm. In some embodiments, the first optical fiber 110 may comprise a 2 m cutoff wavelength of less than 1260 nm, less than 1230 nm or more preferably less than 1200 nm.

In some embodiments, the second optical fiber 112 is a multimode fiber (MMF), wherein the MMF may support more than one linearly-polarized mode at the system wavelength. More specifically, in some embodiments, the second optical fiber 112 is configured as a MMF GRIN lens, which allows for multiple rays to propagate within the core 114. In some embodiments, the second optical fiber 112 may have a parabolic gradient-index profile (e.g., the curvature of the core, α=2), while in other embodiments the curvature of the core of the MMF GRIN lens may not be parabolic (e.g., the curvature of the core, α does not equal 2). In some embodiments, the second optical fiber 112 may have a core 114. The core 114 may have a 25 μm, 50 μm, 62.5 μm or a 100 μm diameter. In some embodiments, the gradient-index profile may define a core curvature value of 1.80>α>2.20.

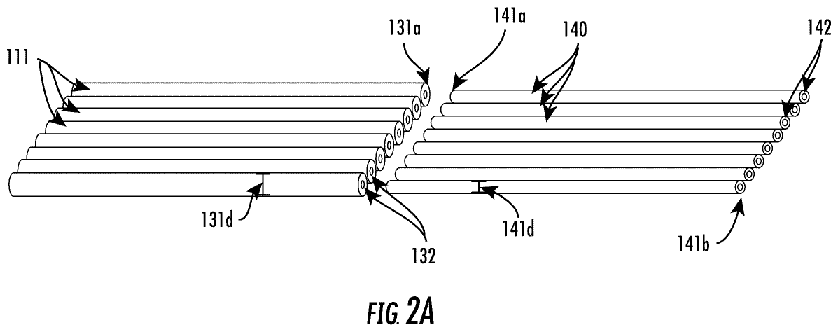

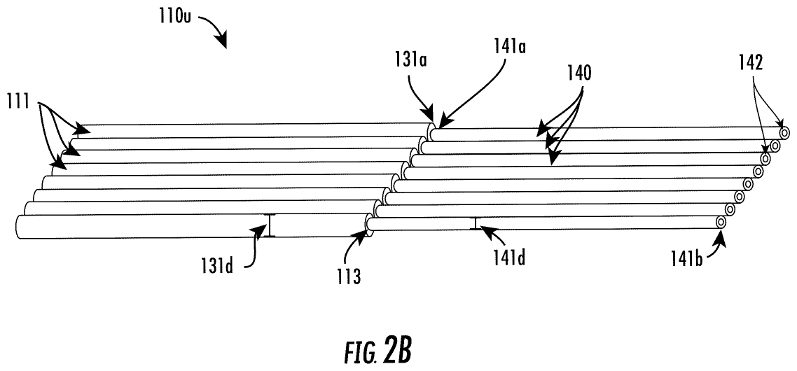

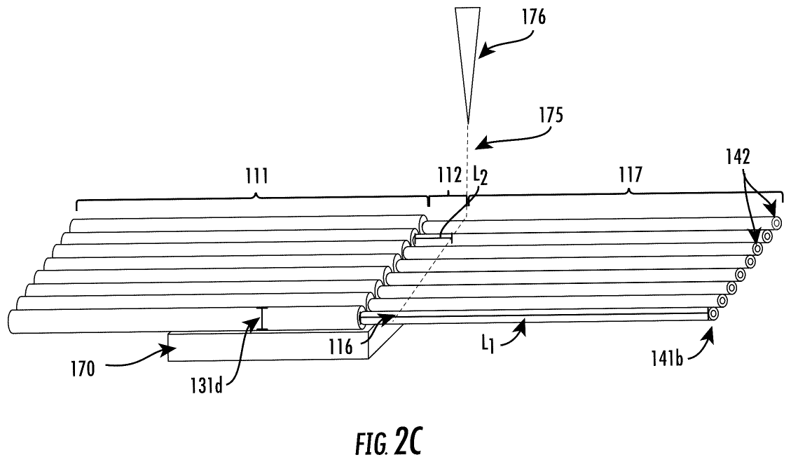

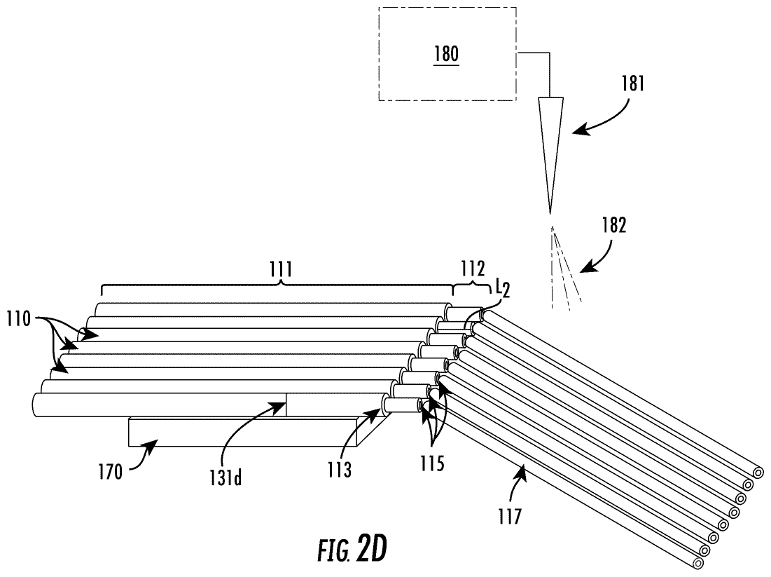

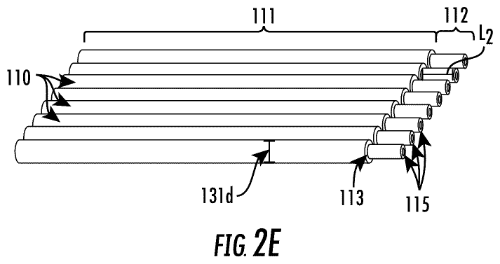

In some embodiments, a fiber length L₂ (see e.g., FIG. 2C) of the second optical fiber 112 extending between the splice position 113 and the cut end 115 defines the output characteristics of the optical fiber 110.

FIGS. 2A-F illustrate example formation of the optical fiber 110 for use in expanded-beam connectors (e.g., FAU 100, a FAU comprising v-grooves or an MPO ferrule comprising micro-holes). FIGS. 2A-B illustrate an uncut optical fiber 110u formed from a first optical fiber 111 having a first diameter 131d and a second optical fiber 140 having a second diameter 141d. In some embodiments, the first diameter 131 is the diameter of the first optical fiber 111 including a core 132 and surrounding cladding (e.g., 133 of FIG. 1). In some embodiments, the first optical fiber 111 may extend from the first end 110a (see e.g., FIG. 1) to a second end 131a. In some embodiments, the second optical fiber 140 may be positioned such that a core 142 of the second optical fiber 140 is aligned with the core 132 of the first optical fiber 111. The second optical fiber 140 may extend between a first end 141a and a second end 141b. In some embodiments, the second diameter 141d is the diameter of the core 142 and the surrounding cladding (e.g., 143 of FIG. 1). In some embodiments, the first diameter 131d is larger than the second diameter 141d, while in other embodiments the first diameter 131d is substantially equivalent to the second diameter 141d.

In some embodiments, the second end 131a of the first optical fiber 111, and the first end 141a of the second optical fiber 140 are cleaved prior to splicing, such as to reduce imperfections and/or promote durable splicing between the first optical fiber 111 and the second optical fiber 140. In some embodiments, the second optical fiber 140 may be trimmed to the fiber length L₂ (see FIG. 2C), prior to splicing with the first optical fiber 111. In other embodiments, the second optical fiber 140 may be spliced to the first optical fiber 111 prior to trimming.

As illustrated in FIG. 2B, the first optical fiber 111 and the second optical fiber 140 may be spliced together, forming the splice position 113. The splice position 113 joins the core 132 of the first optical fiber 111 with the core 142 of the second optical fiber 140. In some embodiments, the first optical fiber 111 and the second optical fiber 140 may be fusion spliced, while in other embodiments, may be mechanically spliced. In a non-limiting example, the first optical fiber 111 and the second optical fiber 140 may be spliced with ribbon splicer, such as a Fujikura 70S+ ribbon splicer. Splicing the first end 141a of the second optical fiber 140 and the second end 131a of the first optical fiber 111 may form an optical variation portion L₁ (e.g., a length of the second optical fiber 140) for the uncut optical fiber 110u that may be used to determine the output characteristics of the optical fiber 110 once the second optical fiber 140 of the uncut optical fiber 110u is cut (e.g., cleaved, trimmed, polished back, etc.) to the desired fiber length.

After splicing, the second optical fiber 140 of the uncut optical fiber 110u may be trimmed to achieve the desired output characteristics. FIG. 2C illustrates the uncut optical fiber 110u placed on a translation stage 170. In some embodiments, the first optical fiber 111 may be positioned on the translation stage 170 while the second optical fiber 140, may extend beyond the translation stage 170.

In some embodiments, the second optical fiber 140 may define the optical variation portion L₁. In some embodiments, the optical variation portion L₁ of the second optical fiber 140 may not yield the desired output characteristics (e.g., the optical variation portion is incorrectly sized). The optical variation portion L₁ may be trimmed to a position (e.g., the cut end 115) defining a fiber length L₂, extending from the splice position 113 to the cut end 115, wherein the position of the cut end 115 along the optical variation portion L₁ produces the desired fiber length corresponding to the desired output characteristics (e.g., collimating and expanded).

In some embodiments, the fiber length L₂ may be an odd multiple of a quarter-pitch length. A quarter-pitch length may be an odd multiple of

$${L}_{\frac{1}{4}} = \frac{2 N - 1}{4} ,$$

where N is a positive integer, of a calculated quarter-pitch length, where at the quarter-pitch length the optical data exits the cut end 115 as an expanded collimated beam. In some embodiments, the fiber length L₂ is within a threshold error length of 20 μm of the calculated quarter-pitch length. In some embodiments, the fiber length L₂ is within a threshold error length of 15 μm, of the calculated quarter-pitch length, and more preferably the fiber length L₂ is within a threshold error length of 5 μm of the calculated quarter-pitch length.

FIG. 2D illustrates an example method of trimming the second optical fiber 140. In some embodiments, a first laser 176 may produce a laser beam 175 and may translate across the second optical fiber 140 to yield perforations 116 though the cladding 143 and the core 142 of the second optical fiber 140. The perforations 116 may divide the second optical fiber 140 into an excess portion 117 and the remaining second optical fiber 112.

In some embodiments, the first laser 176 may be a femtosecond laser, while in other embodiments, the first laser 176 may be a diode-pumped laser. In some embodiments, the laser beam 175 may have a central wavelength between 900-1100 nm, between 950-1080 nm, and between 980-1040 nm. In some embodiments, the laser beam 175 may have a pulse width between 5-20 picoseconds, between 7-15 picoseconds, and between 9-11 picoseconds. In some embodiments, the laser beam 175 may have a repetition rate between 35-75 kHz, between 45-65 kHz, and even between 47-62 kHz. In an example embodiment, the laser beam 175 may have a central wavelength of 1030 nm, a pulse width of 10 picoseconds, and a repetition rate of 50 kHz.

In some embodiments, the laser beam 175 may define a pulse yielding 160 μJ. The first laser 176 may be configured such that the laser beam 175 produced is approximately 1 μm wide and 1 mm long. The first laser 176 may further be configured to move with a translation rate across the uncut optical fiber 140 of 20 mm/s. The translation rate may provide evenly spaced perforations 116 across the second optical fiber 140.

In an alternative embodiment, a parallel diamond cutter may be used to perforate the second optical fiber 140.

As illustrated in FIG. 2D, after the perforations 116 are formed, a force 182 may be applied to the excess portion 117. In some embodiments, the force 182 may be in the form of compressed gas from a gas supply 180 dispensed from a nozzle 181. In some embodiments, the force 182 may be applied at a pressure between 15-65 psi, between 25-55 psi, or between 35-45 psi. In some embodiments, the external force is applied for between 50-500 ms, between 100-400 ms, or between 150-300 ms. In an example embodiment, the force 182 may be compressed air applied to the excess portion 117 at pressure of 40 psi, for about 200 ms. In some embodiments the force 182 is translated across the excess portion 117, while in other embodiments, the force 182 is configured to contact the entire excess portion 117.

The application of the force 182 to remove the excess portion 117 results in the optical fiber 110 having the fiber length L₂ defining the desired output characteristic, as illustrated in FIG. 2E. Accordingly, in some embodiments, the optical fiber 110 may be adhered to the substrate, (see e.g., 120 in FIG. 1), creating the FAU, (see e.g., 100 in FIG. 1). In some embodiments, the FAU may be formed before the perforations are formed and/or before the excess portion 117 is removed. In some embodiments, the optical fiber 110 may be formed into a matrix (e.g., stacked layers). In some embodiments, the optical fibers 110 may be ribbonized, for example, the optical fibers 110 may be adhered to one another rather than to the substrate 120.

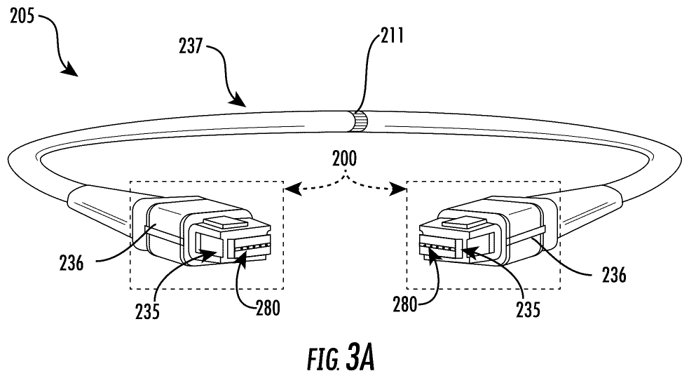

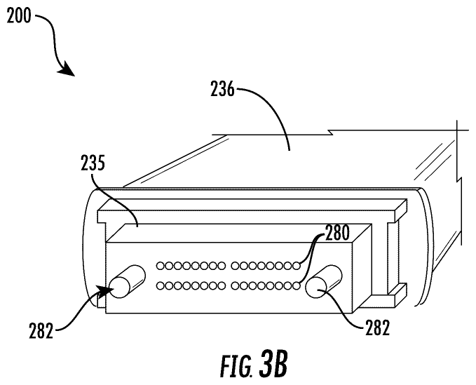

FIG. 3A illustrates an example cable assembly 205. The cable assembly 205 comprises a first optical fiber 211 extending between two connectors 200. Each connector 200 comprises a housing body 236 including a ferrule 235, and at least one ferrule micro-hole 280. In some embodiments, the first optical fiber 211 is contained within an outer cable layer 237. Within the connector 200 each first optical fiber 211 may be spliced to a second optical fiber 212, the second optical fiber being a MMF GRIN lens with a cut end 115 defining a fiber length L₂ (see e.g., FIG. 2E). In some embodiments, the cut end (e.g., 115 FIG. 2E) of the second optical fiber 212 may be positioned at the end face of ferrule 235. In some embodiments, the cut end (e.g., 115 FIG. 2E) of the second optical fiber 212 may be recessed from the end face of the ferrule 235, thus, the connector 200 may be a contactless multi-fiber push-on (MPO) connector. The fiber length L₂ may allow the signals exiting the cut end into the ferrule to collimate and expand, thereby providing larger alignment tolerances as compared to a standard physical contact connector. In some embodiments, the cut end of the second optical fiber may include an anti-reflection coating, thereby allowing low connection losses and low return losses.

In some embodiments, the configuration of the multi-fiber connectors may vary. FIG. 3B illustrates an example configuration of the connector 200. The connector 200 may comprise the housing body 236 which surrounds the splice point between the first optical fibers and the second optical fibers. The connector 200 may further comprise the ferrule 235 on and end of the housing body 236. In some embodiments, the ferrule 235 may comprise a single row of micro-holes 280, while in other embodiments, as illustrated in FIG. 3B, the ferrule 235 may comprise a matrix of micro-holes 280. In some embodiments, the connector housing 200 may be a multi-fiber push-on (MPO) connector configured with 1 or 2 rows of 12 or 16 micro-holes 280 having a pitch of 250 μm. In other embodiments, the connector 200 may comprise one row of 24 micro-holes 280 having a pitch of 165 μm.

In some embodiments, the cut end of the second optical fiber may be positioned within the ferrule opening 280, but not reach the end face of the ferrule 235. In some embodiments, the connector 200 may include guide pins 282 positioned in the ferrule 235. The guide pins 282 may protrude from the ferrule 235, while in other embodiments the ferrule 235 may comprise guide pin holes configured to receive guide pins 282 of another connector 200.

As discussed, the fiber length of the second optical fiber may be manipulated to define the desired output characteristics of the signals propagating within the optical fiber and exiting at the cut end. One method of changing the output characteristic is changing the length of the second optical fiber, such as based on a calculated quarter-pitch length of the second optical fiber.

To explain further, FIGS. 4A-F illustrate a light source 319 entering a first end 312a of an optical fiber 310 and exiting a second end 312b of the optical fiber 310. FIG. 4A illustrates a quarter-pitch length where the light 319 travels through the optical fiber 310. The light 319 enters into the first side 312a of the optical fiber 310 as an expanded collimated beam, propagates within the optical fiber 310, and exits the second end 312b of the optical fiber 310 as a point source 307 of light 319′. Similarly, FIG. 4B illustrates, a quarter-pitch length optical fiber 310. As illustrated, the light source 319 enters the first side 312a of the optical fiber 310 as a point source 307 propagates within the optical fiber 310 and exits the second side 312b as an expanded collimated beam 319′. Thus, when light, or other signal, travels through a quarter-pitch length optical fiber, the light transitions from a collimated expanded state, to a focusing state, or from a focused state to an expanded collimated state.

FIGS. 4C-D illustrate example optical fibers 310 extending two quarter-pitch lengths. In FIG. 4C the light 319 enters as an expanded collimated beam, collimates within the optical fiber 310 and the light 319 exits the second side 312b as an expanded collimated beam. Similarly, illustrated in FIG. 4D the light 319 enters into the first end 312a of the optical fiber 310 as a focused beam, collimates within the optical fiber 310, and the light 319′ exits the second side 312b as a focused beam. Thus, since the optical fiber 310 is two quarter pitch lengths, the light exits the second side 312b in the same configuration the light 319 entered into the first end 312a of the optical fiber 310.

FIGS. 4E-F illustrate example optical fiber 310 extending three quarter-pitch lengths. In FIG. 4E, the light 319 enters into the first side 312a of the optical fiber 310 as an expanded collimated beam, propagates within the optical fiber 310 and the light 319′ exits the second side 312b of the optical fiber 310 as a point source. Similarly, illustrated in FIG. 4E the light 319 enters into the first side 312a of the optical fiber 310 as a point source, propagates within the optical fiber 310 and exits the second end 312b of the optical fiber as an expanded collimated beam.

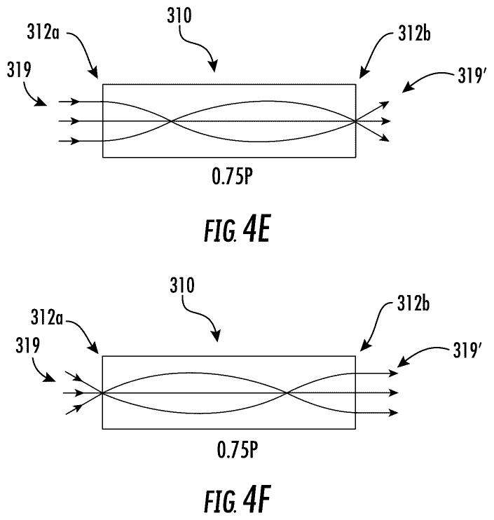

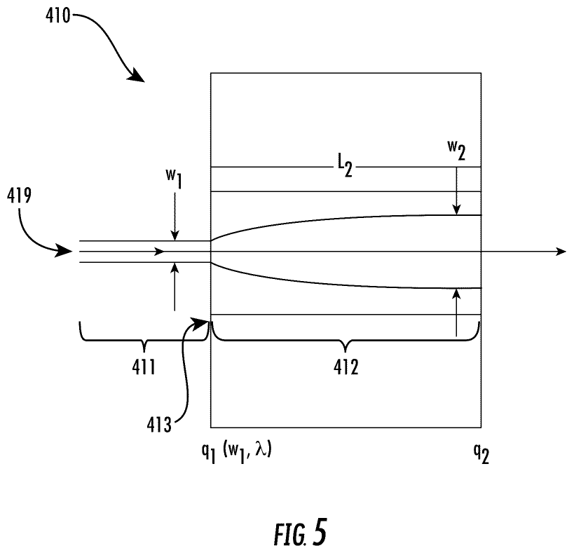

With respect to the optical fiber 110 depicted in FIG. 1, the optical fiber 110 may be a single-mode fiber optically coupled to a multimode fiber. The LP₀₁ mode propagating in the core of the single-mode fiber may be characterized by a Gaussian intensity profile having a half-width w₁, as shown in FIG. 5. The optical field may be expanded and collimated in the same manner as the point source illustrated in FIGS. 4A-F.

To properly create an expanded beam connector, the fiber length of the second optical fiber needs to be accurately calculated. In general, models used to estimate the quarter-pitch length of a gradient-index lens fiber assume that the curvature of the core of the MMF is parabolic and that the refractive index profile may be represented by:

$${n}^{2} ( r ) = {n}_{0}^{2} [ 1 - 2 {{Δ}_{0} ( \frac{r}{a} )}^{2} ] , 0 \leq r \leq a \qquad ( 1 )$$

Where n₀ is the maximum refractive index, Δ₀ is the maximum relative refractive index, and a is the core radius. The quarter-pitch described this refractive index profile is:

$${L}_{\frac{1}{4}} = \frac{π a}{2 \sqrt{2 {Δ}_{0}}} \qquad ( 2 )$$

Using equation 2, for a MMF with a core radius, a, of 25 microns and a peak relative refractive index, Δ₀ of 0.01=1.0%, the calculated quarter-pitch length is 277.7 microns. However, Eq. (1) does not accurately describe the refractive index profile that minimizes the delays of the skew modes propagating in the core of a MMF and will thus not yield an accurate quarter-pitch value. That refractive index profile is described by

$${n}^{2} ( r ) = \frac{{n}_{0}^{2}}{[ 1 + \frac{2 {Δ}_{0}}{1 - 2 {Δ}_{0}} {( \frac{r}{a} )}^{α} ]} \qquad ( 3 )$$

where

$${Δ}_{0} = \frac{{n}_{0}^{2} - {n}_{cl}^{2}}{2 {n}_{0}^{2}} ;$$

α is the core curvature; and n_{cl} is the refractive index of the cladding.

The value of the core curvature α is typically between 1.9 and 2.2 for MMFs designed to have high modal bandwidth at an operating wavelength between 800 and 1600 nm. Since the curvature of a MMF core with an alpha value in this range is nearly parabolic, Eq. (3) may be expanded with a Taylor series to obtain:

$${n}^{2} ( r ) = {n}_{0}^{2} [ 1 - \frac{2 {Δ}_{0}}{1 - 2 {Δ}_{0}} {{C}_{α} ( \frac{r}{a} )}^{2} ] , \qquad ( 4 )$$

wherein C_{α} is a nonlinear correction that can be averaged over the core profile by integration:

$${C}_{α} = 1 + \frac{1}{a} {\int }_{0}^{a} {δ ( \frac{r}{a} )}^{δ} ln ( \frac{r}{a} ) \qquad ( 5 )$$

The quarter-pitch associated with Eq. (3) is then described by

$${L}_{\frac{1}{4}} = \frac{π a}{2} \sqrt{\frac{1 - 2 {Δ}_{0}}{2 {C}_{α} {Δ}_{0}}} \qquad ( 6 )$$

Equation 6 allows one to accurately calculate a nominal quarter-pitch length for a MMF GRIN lens for measured or known values of the maximum relative refractive index, the core radius, and the core alpha.

In some embodiments, different types of optical fibers may define different core curvature profiles. For example, the Corning ClearCurve® OM4 fibers may define similar core profiles with a mean alpha value of about 2.12, and with a range of alphas from 2.09-2.15. Discussed further herein the range of alphas may have a smaller impact on the quarter-pitch length calculation in comparison to variations in the radius and maximum refractive index of the gradient-index core. For example, the OM4 alpha range may result in quarter-pitch variations of up to a few microns, whereas a similar variation in the refractive index profiles may result in quarter-pitch variations of up to 10 microns. Thus, when choosing the MMF to use within an array, OM4 fibers having a similar refractive index profile, may define a range of alphas, a range of maximum relative refractive index values, and a range of radius values, and may be within the tolerance to be used as an expanded beam connector.

FIG. 5 illustrates propagation of a Gaussian beam through a generic coupling of an optical fiber 410 between a first optical fiber 411 (e.g., an input waveguide) and a second optical fiber 412 (e.g., a MMF GRIN lens). The qᵢ variables designate the complex curvature parameters at a splice position 413 and a cut end 415 of the second optical fiber 412. In some embodiments, the first optical fiber 411 is a single-mode fiber with a step-index core. In some embodiments, the second optical fiber 412 is a MMF GRIN lens having a core diameter of 50 microns, or 100 microns. In some embodiments, a fiber length of the second optical fiber 412 is an odd multiple pitch of (2N−1)/4, wherein N is a positive integer of the calculated quarter-pitch length.

In some embodiments, the fiber length of the second optical fiber 412 is at least 100 microns. In some embodiments, the fiber length of the second optical fiber 412 is between 100-5,000 microns to ensure that the bare glass is completely incorporated into the V-groove array (e.g., FAU 100) or the ferrule.

In some embodiments, the complex curvature of the output beam by the first optical fiber 211 is provided by:

$${q}_{i} = \frac{i ( π {w}_{1}^{2} )}{λ} = {iz}_{1} \qquad ( 7 )$$

Where w₁ is the mode field radius (half of the mode field diameter (MFD)), and λ is the wavelength of the light in a vacuum. The ABCD law may be used to show that the real and imaginary parts of the complex curvature parameter after the beam propagates a distance z in the second optical fiber 412 are:

$$Re ( {q}_{2} ) = \frac{sin ( κ z ) cos ( κ z ) [ 1 - {n}_{0}^{2} {κ}^{2} {z}_{1}^{2} ]}{{n}_{0} κ [ {cos}^{2} ( κ z ) + {n}_{0}^{2} {κ}^{2} {z}_{1}^{2} {sin}^{2} ( κ z ) ]} \qquad ( 8 a )$$

$$and$$

$$lm ( {q}_{2} ) = \frac{{z}_{1}}{[ {cos}^{2} ( κ z ) + {n}_{0}^{2} {κ}^{2} {z}_{1}^{2} {sin}^{2} ( κ z ) ]} , \qquad ( 8 b )$$

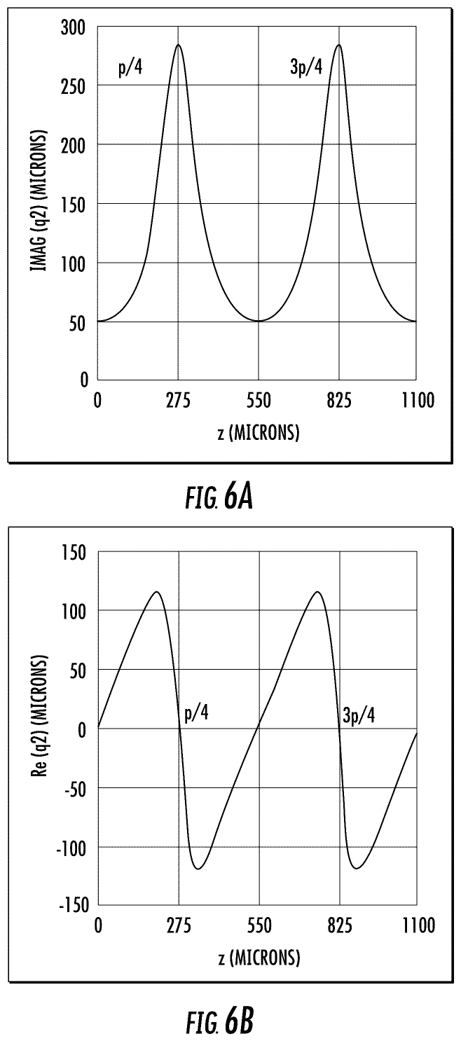

Respectively. FIGS. 6A-B illustrate the imaginary and real components of q₂ for a MMF GRIN lens over one full pitch (e.g., where the full pitch is about 1100 microns), assuming an input Gaussian beam with a half width of w₁=5 microns. The refractive index profile of the MMF GRIN lens is based on the nominal profile for the optical fiber used, and optimized for 1550 nm with a maximum relative refractive index of Δ₀=1.00%, core radius a=25 microns, and an alpha value of 2.0. In FIG. 6A, illustrating the imaginary portion of q₂, there is a sharp peak at the quarter-pitch length, and odd multiples thereof. In contrast, as illustrated in FIG. 6B the real portions of q₂ pass through 0 at the quarter-pitch length and odd multiples thereof, having a negative slope. The half beam-width is related to the imaginary part of the complex curvature by equation:

$${w}_{2} = \sqrt{\frac{λ Im ( {q}_{2} )}{π}} , \qquad ( 9 )$$

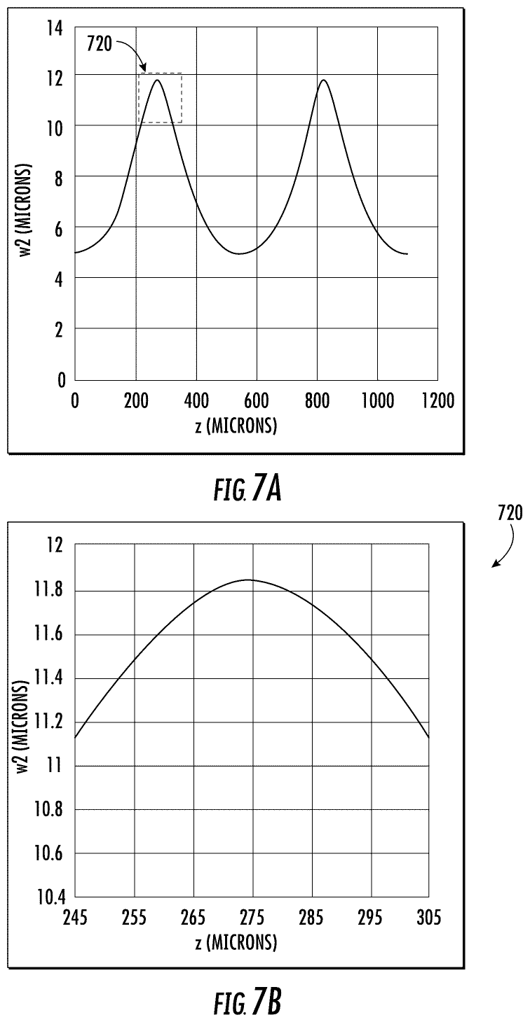

The half-beam width is illustrated in FIGS. 7A-B. FIG. 7A illustrates the half-beam width across the entire pitch of the optical fiber, and FIG. 7B illustrates a portion 720 of the half-beam width for a range of about ±30 microns around the quarter-pitch. FIGS. 7A-B illustrate that the beam diameter at each odd multiple of the quarter pitch length collimates and expands to a diameter of about 24 microns. Thus, when an assembly (e.g., expanded beam connector 200) comprises a first optical fiber (e.g., 211 in FIG. 2A) connected to a second optical fiber (e.g., 212 in FIG. 2A) when the second optical fiber defines a fiber length equal to an odd multiple of the quarter-pitch length, the assembly functions as an expanded beam connector that does not require physical contact to achieve low optical coupling losses.

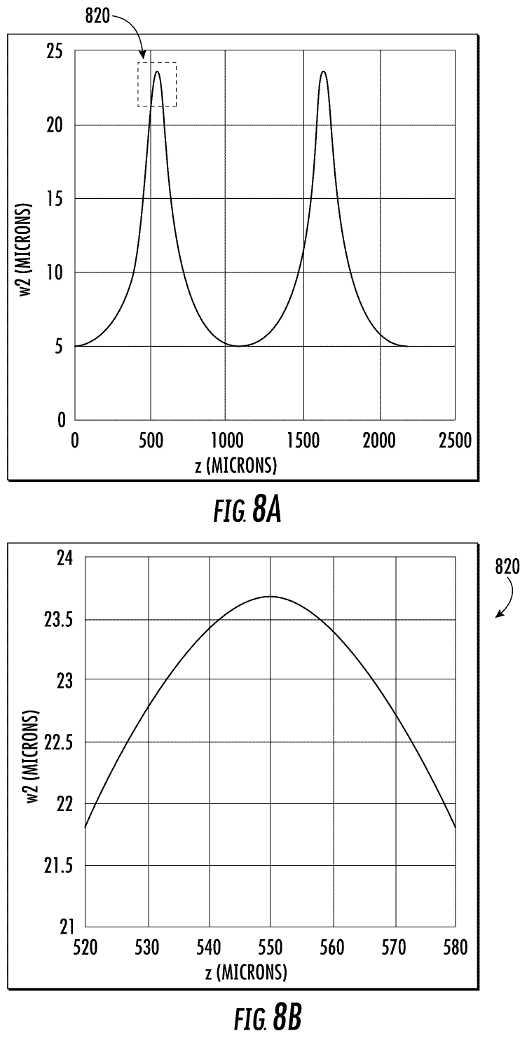

Further, a larger expanded beam may be formed by using a second optical fiber with a larger core diameter. For example, FIGS. 8A-B illustrate the half-width of a beam transmitted through a MMF GRIN lens with a core diameter of 100 microns. FIG. 8A illustrates the half-width over a full pitch, while FIG. 8B illustrates a portion 820 of the half-width for a range of about ±30 microns around the quarter-pitch. Thus, the beam diameter at each odd quarter-pitch length is about 48 microns.

The spot size through an odd multiple of the quarter-pitch length of a MMF GRIN lens may be determined by combining equations 1, 3, 8b, and 9:

$${w}_{2} = \frac{λ}{π {n}_{cl} {w}_{1}} \frac{a ( 1 - 2 {Δ}_{0} )}{\sqrt{2 {C}_{α} {Δ}_{0}}} \qquad ( 10 )$$

To explain FIGS. 6A-6B further, the graphs are relevant to a system where the input beam (e.g., from the first optical fiber) may be characterized by a Gaussian profile with a width of 2w₁=10 microns. This profile is consistent with the first optical fiber having a mode field diameter in a range of about 8.5 to 9.5 microns at 1210 nanometers, and a mode field diameter in a range of about 10 to 11 microns at 1550 nanometers.

In some embodiments, the second optical fiber GRIN lens may be formed from a multimode fiber having a core diameter of 50 microns, which collimates and expands the beam by 100-150%. The example assembly does not require a new optical fiber or a spherical splicer, thus lowering manufacturing costs. However, as illustrated with respect to FIGS. 8A-B, a multimode optical fiber having a core diameter of 100 microns and a cladding diameter of up to 125 microns, may expand the input launch from the first optical fiber (e.g., single-mode fiber) by another factor of 2 which may further improve the tolerance of the connector to lateral misalignments.

In some embodiments, the target pitch value may be necessary for values other than the maximum relative refractive index of alpha and the core.

In some embodiments, to overcome the lack of knowledge of the refractive index profile of the MMF, a measurement process may be used to literately adjust the length of the MMF, after each measurement, however this would be a time-consuming process, and would be costly.

In some embodiments, the quarter-pitch length equations may be tailored to each type of optical fiber, for example, Corning Clearcurve® OM4 MMF, Corning Clearcurve® OM5 MMF, and Corning Clearcurve® LX MMF.

Equation 3 may be applied to different MMFs manufactured. For example, the equation may be applied to an OM4 MMF wherein Δ₀, a, and α are obtained by numerically fitting the measured refractive index profile over the range from

$$\frac{r}{a} = 0.2 , to \frac{r}{a} = 0.9 ,$$

and wherein α between 2.09 and 2.15. Similarly, the equation may be used for a OM5 MMF with an α between 2.09 and 2.11, and for an α between 2.00 and 2.04 for a MMF optimized to have high modal bandwidth at 1310 nm.

In some embodiments, the fiber lengths may be an odd multiple of a quarter pitch length. For example, if the calculated quarter pitch length is 300 microns, the fiber length may be any multiple of (2N−1)/4 where N is a positive integer. Thus, the fiber length may be 300 microns, 900 microns, 1500 microns etc. In some embodiments, the optimal fiber length may be between 100 microns and 5000 microns.

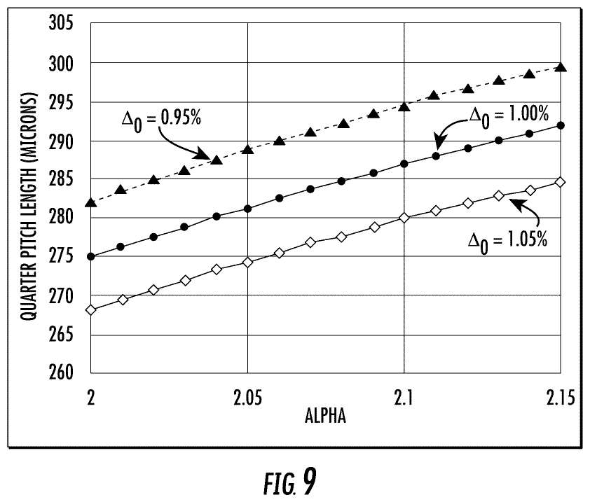

FIG. 9 illustrates the effect of using a proper alpha, on the calculated quarter-pitch length, for an optical fiber with a core radius of 25 microns and a Δ₀ of 0.95%; a core radius of 25 microns and a Δ₀ of 1.00%, and a core radius of 25 microns and a Δ₀ of 1.05%. Thus, as illustrated for Δ₀ of 0.95%; the quarter pitch length may vary between 268 for an α=2 (e.g., the parabolic equation), to 285 microns for an α=2.15, about a 17 micron difference.

As discussed above with respect to equation 2, using a core radius of 25 microns and a Δ₀ of 1.00%, the quarter-pitch length may vary between 275 microns and 292 microns, which is much larger than the desired tolerances of ±10 microns, and more preferably ±5 microns. Thus, to accurately calculate the quarter-pitch length the curvature of the core needs to be accurately represented.

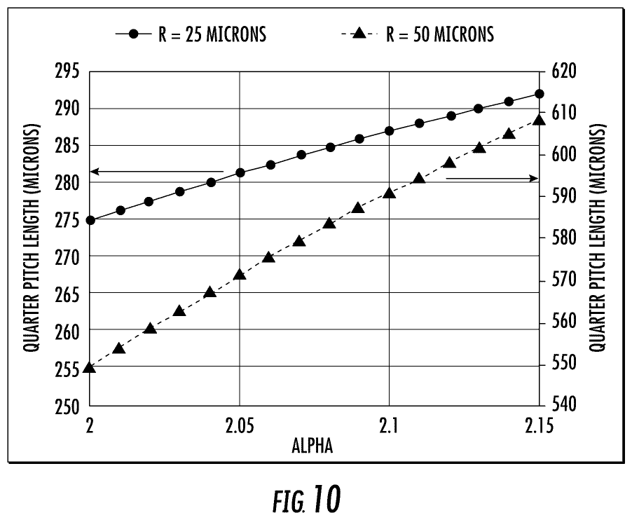

In some embodiments, the second optical fiber may be a large core multimode fiber. The large core MMF may be used to create an expanded beam connector that with proper selection of the optical fibers for the fiber array may be used for data center operation. FIG. 10 illustrates the dependence of the quarter-pitch length on alpha for a MMF with a maximum refractive index Δ₀ of 1.00%, and a core radius of 25 microns and 50 microns. As illustrated in FIG. 10 the quarter pitch length for the smaller core radius a=25 micron fiber ranges between 277 microns and 293 microns for a range of about 16 microns. While the quarter pitch length for the larger core radius a=50 microns, ranges between 550 to 610 microns for a range of about 70 microns. Thus, the variation in alpha is more pronounced in the larger optical fibers because the optical signal has to travel a longer distance to be fully collimated.

### EXAMPLES

In an example optical transmission system, a light source may transmit at a bit rate of 25 GHz or higher at one or more wavelengths in the wavelength range between 1520-1620 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 24-26 microns, a core curvature value between about 2.09 and 2.15, and a maximum relative refractive index in the range of 0.95% and 1.05%. The second optical fiber may further comprise a minimum effective modal bandwidth (minEMB) at 850 nm greater than 4700 MHz-km. In some embodiments, the second optical fiber comprises a fiber length between 279-299 microns.

In another example optical transmission system, a light source may transmit at a bit rate of 25 GHz or higher at one or more wavelengths in the wavelength range between 1520-1620 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 24-26 microns, a core curvature value between about 2.09 and 2.11, and a maximum relative refractive index in the range of 0.95% and 1.05%. The second optical fiber may further comprise a minEMB at 850 nm greater than 4700 MHz-km, and a minEMB at 953 nm greater than 2470 Mhz-km. In some embodiments, the second optical fiber comprises a fiber length between 277-297 microns.

In another example optical transmission system, a light source may transmit at a bit rate of 25 GHz or higher at one or more wavelengths in the wavelength range between 1260-1340 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 24-26 microns, a core curvature value between about 2.00 and 2.04, and a maximum relative refractive index in the range of 0.95% and 1.05%. The second optical fiber may further comprise a minEMB at 1310 greater than 4000 MHz-km. In some embodiments, the second optical fiber comprises a fiber length between 268-288 microns.

In another example optical transmission system, a light source may transmit at a bit rate of 25 GHz or higher at one or more wavelengths in the wavelength range between 1520-1620 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 48-52 microns, a core curvature value between about 2.09 and 2.15, and a maximum relative refractive index in the range of 0.95% and 1.05%. The second optical fiber may further comprise a minEMB at 850 nm greater than 4700 MHz-km. In some embodiments, the second optical fiber comprises a fiber length between 588-608 microns.

In another example optical transmission system, a light source may transmit at a bit rate of 25 GHz or higher at one or more wavelengths in the wavelength range between 1520-1620 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 48-52 microns, a core curvature value between about 2.09 and 2.11, and a maximum relative refractive index in the range of 0.95% and 1.05%. The second optical fiber may further comprise a minEMB at 850 nm greater than 4700 MHz-km, and a minEMB at 953 nm greater than 2470 Mhz-km. In some embodiments, the second optical fiber comprises a fiber length between 581-601 microns.

In another example optical transmission system, a light source may transmit at a bit rate of 25 GHz or higher at one or more wavelengths in the wavelength range between 1260-1340 nm. In some embodiments, the optical transmission system may include a first optical fiber and a second optical fiber connected at a splice position. In some embodiments, the first optical fiber may be a single-mode fiber. The first optical fiber may comprise a cable cutoff wavelength less than 1260 nm and a mode field diameter (MFD) at 1310 nm in the range of 8.6-9.5 microns. In some embodiments, the second optical fiber may be an MMF having a core radius between 48-52 microns, a core curvature value between about 2.00 and 2.04, and a maximum relative refractive index in the range of 0.95% and 1.05%. The second optical fiber may further comprise a minEMB at 1310 nm greater than 4000 MHz-km. In some embodiments, the second optical fiber comprises a fiber length between 548-568 microns.

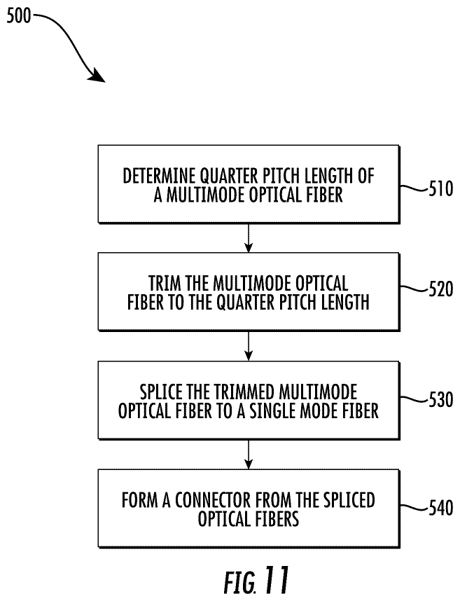

FIG. 11 is a flowchart illustrating an example method 500 for forming an expanded beam connector in accordance with some embodiments discussed herein. At operation 510, the quarter-pitch length of a multimode fiber is determined. Optionally the curvature of the optical fiber, and the maximum relative refractive index may be determined for use in calculating the quarter-pitch length of the multimode fiber. At operation 520, the multimode fiber may be trimmed to the determined quarter pitch length (or multiple thereof). In some embodiments, the fiber may be trimmed with laser perforations, polishing the optical fiber back to the calculated quarter-pitch length, or other method of trimming the optical fiber. At operation 530, the trimmed multimode fiber may be spliced to a single mode fiber. At operation 540, a connector may be formed using the spliced optical fibers.

Notably, the above operations for FIG. 11, while described in a certain order, may be performed in a different order and/or some of the operations may be performed simultaneously.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An expanded beam connector, comprising:
an array of spliced optical fibers, wherein each spliced optical fiber within the array of spliced optical fibers comprises:
a first optical fiber, wherein the first optical fiber is a single-mode fiber;
a second optical fiber spliced with the first optical fiber at a splice position, wherein the second optical fiber is a gradient-index multimode fiber,
wherein the second optical fiber defines a fiber length extending between the splice position and a cut position,
wherein the cut position is the same for each of the second optical fibers of the array of spliced optical fibers,
wherein the fiber length is configured as a multiple of a quarter-pitch length, and wherein, at the quarter-pitch length, a wave transmission through the second optical fiber between the splice position and the cut position causes the wave to collimate at the cut position; and
a connector surrounding at least the splice position of each spliced optical fiber within the array of spliced optical fibers.

2. The expanded beam connector of claim 1, wherein the quarter-pitch length is based on a core radius of the second optical fiber, a maximum relative refractive index of the second optical fiber and a core alpha value of the second optical fiber.

3. The expanded beam connector of claim 2, wherein the quarter-pitch length is provided by the following equation:
$${L}_{\frac{1}{4}} = \frac{π a}{2} \sqrt{\frac{1 - 2 {Δ}_{0}}{2 {C}_{α} {Δ}_{0}}} ,$$
wherein L_{1/4}, is the quarter-pitch length, a is the core radius of the second optical fiber, Δ₀ is the maximum relative refractive index of the second optical fiber, α is the core alpha of the second optical fiber, and
$${C}_{α} = 1 + \frac{1}{a} {\int }_{0}^{a} ( 2 - α ) {( \frac{r}{a} )}^{( 2 - α )} ln ( \frac{r}{a} ) .$$

4. The expanded beam connector of claim 1, wherein the second optical fiber comprises a core radius between 24-26 microns.

5. The expanded beam connector of claim 1, wherein the second optical fiber comprises a maximum relative refractive index between 0.95%-1.05%.

6. The expanded beam connector of claim 1, wherein the quarter-pitch length is between 268-299 microns.

7. The expanded beam connector of claim 1, wherein the quarter-pitch length of each of the second optical fibers are within a threshold error length that is less than ±20 microns.

8. The expanded beam connector of claim 7, wherein the threshold error length is less than ±10 microns.

9. The expanded beam connector of claim 1, wherein the wave transmission is a light with a wavelength between 1520 and 1620 nm.

10. The expanded beam connector of claim 1, wherein the second optical fiber comprises a minimum effective modal bandwidth (minEMB) value at 850 nm of greater than 4700 MHz-km.

11. The expanded beam connector of claim 1, wherein the wave transmission is a light with a wavelength between 1260-1360 nm.

12. The expanded beam connector of claim 11, wherein the second optical fiber comprises a minEMB value at 1310 nm of greater than 4000 MHz-km.

13. The expanded beam connector of claim 1, wherein the expanded beam connector is contactless.

14. The expanded beam connector of claim 1, further comprising an anti-reflection coating disposed on the cut end of the second optical fiber.

15. The expanded beam connector of claim 1, further comprising a ferrule enclosed within the connector, wherein the second optical fiber is positioned within the ferrule.

16. The expanded beam connector of claim 15, wherein the plurality of second optical fibers are recessed within the ferrule.

17. The expanded beam connector of claim 1, wherein the fiber length is between 100-5,000 microns.

18. A method of making an expanded beam connector, the method comprising:
forming a plurality of spliced optical fibers by splicing a plurality of first optical fibers to a plurality of second optical fibers at a splice position, wherein the plurality of first optical fibers are single-mode fibers, and wherein the plurality of second optical fibers are gradient-index multimode fibers;
forming an array of spliced optical fibers, wherein the splice position of each of the plurality of spliced optical fibers is aligned;
determining a quarter-pitch length for the plurality of second optical fibers within the plurality of spliced optical fibers, wherein the quarter-pitch length is configured such that a wave transmission traveling through the plurality of second optical fibers collimates at a cut position, wherein the cut position is opposite the splice position;
trimming the plurality of second optical fibers to a fiber length, wherein the fiber length is a multiple of the quarter-pitch length; and
positioning the array of spliced optical fibers in a connector, wherein at least a portion of the plurality of first optical fibers, the splice, and the plurality of second optical fibers are within the connector.

19. The method of claim 18, wherein the quarter pitch length is provided by the following equation:
$${L}_{\frac{1}{4}} = \frac{π a}{2} \sqrt{\frac{1 - 2 {Δ}_{0}}{2 {C}_{α} {Δ}_{0}}} ,$$
wherein L_{1/4}, is the quarter-pitch length, a is the core radius of the second optical fiber, Δ₀ is the maximum relative refractive index of the second optical fiber, α is the core alpha of the second optical fiber, and
$${C}_{α} = 1 + \frac{1}{a} {\int }_{0}^{a} ( 2 - α ) {( \frac{r}{a} )}^{( 2 - α )} ln ( \frac{r}{a} ) .$$

20. The method of any of claim 18, further comprising:
positioning a cut end of the plurality of second optical fibers into a ferrule, wherein the cut end of the plurality of second optical fibers are recessed in the ferrule.
